(19) United States
(12) Patent Application Publication
(10) Pub. No.: US 2014/0032440 A1
(43) Pub. Date: Jan. 30, 2014

(54) EVALUATING TRANSPORTATION AGREEMENT DATA RECORDS

(71) Applicants: Sudhindra CHANDRASHEKAR, Bangalore (IN); Krithika Kumar IYER, Bangalore (IN)

(72) Inventors: Sudhindra CHANDRASHEKAR, Bangalore (IN); Krithika Kumar IYER, Bangalore (IN)

(73) Assignee: SAP AG, Walldorf (DE)

(21) Appl. No.: 13/559,052

(22) Filed: Jul. 26, 2012

(51) Int. Cl. G06Q 10/08; G06Q 50/28

(52) U.S. Cl. 705/335

(57) ABSTRACT

Freight costs may be calculated by selecting an agreement from many different possible agreements and then aggregating shipping costs specified in shipping cost fields of the selected agreement. An agreement may be selected depending on a relative hierarchy of a party specified in a party field of a transportation agreement record as compared to the other transportation agreement records relating to the shipping route. Each of the identified transportation agreement records relating to the shipping route may classified according to the relative of hierarchy of in the party specified in the record in relation to the hierarchy of other parties in the other identified records. A leading charge type indicator may be considered during the agreement selection process.

### BACKGROUND

Organizations involved in the transportation of goods may have multiple shipping policies, terms, and/or agreements negotiated by business entities that may apply to a particular shipping route. For example, shipping goods from one country to another country may involve additional taxes, surcharges, and costs than shipping goods within a single country. Different entities in an organization may also negotiate different shipping terms with different customers. A customer with global shipping needs may, for example, negotiate a global rate agreement with the organization's headquarters office for shipping different goods around the world. A local customer who has more limited shipping needs may negotiate a different agreement with a local branch of the organization subject to particular cost constraint specified by headquarters office or others at higher levels of the organization.

Conflicts and related consistency problems have occurred when attempting to calculating freight costs using shipping terms obtained from multiple agreements. In the past it has been difficult to automatically determine shipping terms and costs in different agreements that may apply to a particular shipping route of a particular good. For example, if two separate agreements both contained different fees relating a same issue, it was difficult to ascertain which set of fees should used to calculate the shipping cost.

In the past these issues had been resolved by manually accounting for and resolving every possible conflict scenario between different agreement terms. This approach is very cost and labor intensive and may not be practical in situations where there are many different agreements that may apply to a particular shipping route.

There is a need for automatically determining shipping cost terms in different transportation agreement records and automatically calculating a freight cost for a good in situations involving shipping cost terms from multiple transportation agreements.

### BRIEF DESCRIPTION OF THE DRAWINGS

FIG. 1 shows an exemplary process for calculating a freight cost for a good.

FIG. 2 shows an exemplary hierarchical classification of transportation agreement records.

FIG. 3 shows an exemplary architecture.

### DETAILED DESCRIPTION

Freight costs may be calculated by selecting and then simulating shipping costs specified in shipping cost fields in multiple transportation agreement records relating to a shipping route. Shipping costs may be selected from different cost fields depending on a relative hierarchy of a party specified in a party field of a transportation agreement record as compared to the party specified in other transportation agreement records relating to the shipping route. A leading charge type field may be used to identify agreement records that contain shipping cost data related to the particular shipping route. If more than one agreement record have shipping cost data related to particular shipping route as indicated in the leading charge type field, then the relative hierarchy of a party in each of the agreements records may be compared to select the agreement record at the lowest hierarchical level as compared to the other identified agreement records.

Each of the agreement records may contain a complete set of shipping charges that are used to calculated the freight cost, thought the shipping charges may vary in different agreements. For example, a local city office of an organization may have an agreement or policy to charge customers a local delivery surcharge because of congestion delays, additional local taxes, or extra costs incurred in traveling to particular locations within the local city area. An agreement at the local city office level may include additional shipping charges to account for these surcharges while other agreements need not include these surcharges but may include different charges. The parties, such as the local city office, that may be specified in the party field of the transportation agreement records may represent different regional entities of an organization responsible for different transportation agreement terms.

A state or country division of the organization that encompasses the local city office may also have agreements or policies to charge customers particular rates for transporting goods. For instance, there may be a processing surcharge for deliveries arranged through the state or country division instead of the through the local city office. This additional processing surcharge may be included in agreements at the state or country division level but not at the local city office level. Other entities in the organization may have different cost terms and/or policies that may apply in different situations. There may also be some shipping cost fields, such as a state or country tax field that are included in multiple agreements, such as those at both the state or country level and the local city office level.

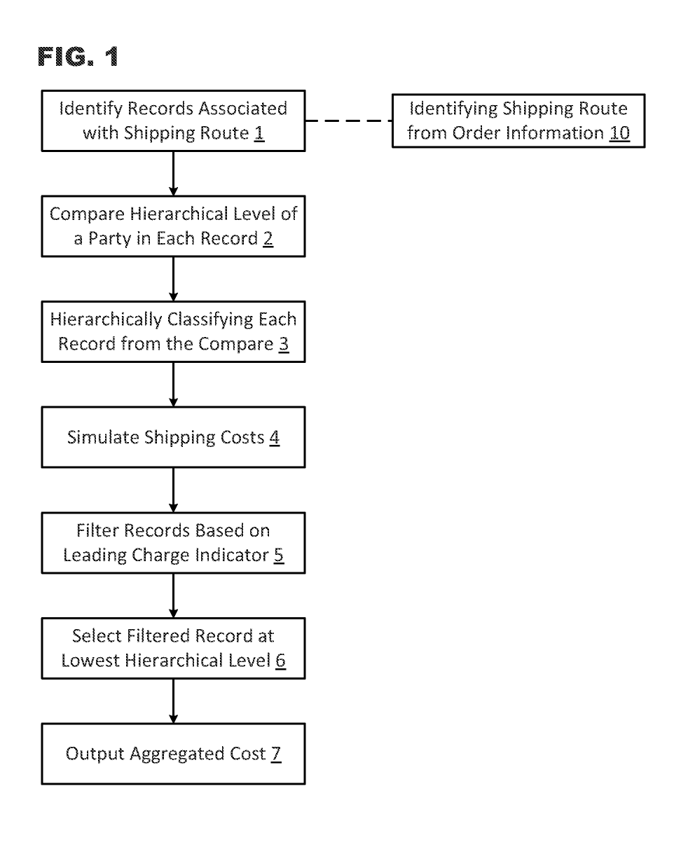

FIG. 1 shows an exemplary process for calculating a freight cost for a good. The process may be performed by a processing device. In some instances, the process may be stored in instructions encoded in a non-transitory computer readable medium, that when executed by the processing device, cause the processing device to perform the process.

In box 1, a plurality of transportation agreement records may be identified that contain data fields specifying shipping costs associated with a shipping route for the good and identifying a party to a transportation agreement. In some instances, a transportation agreement record may include a geographic coverage region data field that specifies at least one location or geographic region to which a transportation agreement cost stored in the shipping cost data field of the transportation agreement record applies. The location information included in the geographic coverage region data field may then compared to the shipping route for the good to determine whether a location specified in the geographic coverage region data field is associated with the shipping route. If the location is not part of the shipping route, then the shipping costs need not be associated with the shipping route. If the location is part of the shipping route, then the shipping costs and the transportation agreement record containing the shipping costs may be associated with the shipping route.

As indicated in box 10, in some instances, a shipping route may be identified from order information included in a sales order object. The sales order object may specify an origin and/or a destination of the good, which may be used to identify the shipping route. In some instances, the shipping route may be automatically determined based on the good and the destination specified in the order information. A known source of the good may be identify and a shipping route may be selected based on the source and destination. In some instances, the transportation agreement records containing a shipping cost data field or other term relating to the source, destination, and/or waypoint of the shipping route may be identified as associated with the shipping route.

Once the transportation agreement records associated with the shipping route have been identified, a relative hierarchical level of a party specified in each of the identified transportation agreement records may be determined. The relative hierarchical level may be determined from an organization chart or other data source indicating a relative ranking of different entities. The other data source may rank parties based on different criteria, such a relative geographical region covered by the parties, a financial size of the parties, or other metric that may be used to rank the parties.

In box 2, a relative hierarchical level of the party in each of the identified transportation agreement records may be compared to that of others in the other agreement records. As one non-limiting example, the comparing of the relative hierarchical level of each of the identified parties may be based on a position of each party in the hierarchical organizational chart. As another non-limiting example, the comparing of the relative hierarchical level of each of the identified parties may be based on a geographic region associated with each party with each party's relative hierarchical level proportional to a size of the geographic region associated with the respective party. Other comparing criteria may be used in different situations depending on the metric that is used to rank to the parties.

As a result of this comparing, in box 3, each of the identified transportation agreement records may be hierarchically classified according to the compared relative hierarchical level of each respective party.

The classified transportation agreement records may then be each analyzed depending on their hierarchical classification. For example, in box 4, the shipping costs may be simulated for each of the agreements.

In box 5, evaluation logic may be applied to each of the simulated shipping costs to determine which of the hierarchical agreements should be used. For example, in some instances the evaluation logic may scan the classified transportation agreement records and identify the agreement record including a particular shipping rate or charge that may be identified as a leading charge type. The agreement records may be filtered to exclude those records that do not identify the particular shipping rate or charge as the leading charge type.

In box 6, the evaluation logic may then select, from any remaining agreement records that were not excluded through the filtering, a final agreement record used to calculate the freight cost for the good. The selection of the final agreement record may be based on the hierarchical classification of the remaining agreement records. In some instances, the evaluation logic may select the agreement record at the lowest hierarchical classification level. In other instances, other selection criteria may be used. For example, the agreement record at a highest or other classification level may be selected or the agreement record having the cheapest or costliest rates may be selected.

In box 7, the calculated freight cost for the good may be outputted. The outputting of the calculated freight cost may include outputting the freight cost to a memory, register, screen, printer, storage device, or other process or program. Thus, in some instances, the freight cost may be immediately outputted to a display or printer for the user to see, but in other instances the freight cost may be outputted as an input to another program or process, such as a program that calculates a total cost for the user that combines the cost of the good with the calculated freight costs to determine a final total cost.

For example, in some situations, different entity in an organization may negotiate or provide different fees and/or costs associated with transportation a good. If a global transportation agreement is negotiated between the headquarters office of a company and a customer for worldwide delivery of goods, then the terms of that agreement may apply to all deliveries of that customer and may be included in each of the agreement records. On the other hand, if the local customer negotiates a deal with a local office to transport goods regionally, the negotiated terms of the local customer deal may be different than the global agreement negotiated at the headquarters level and these additional terms may be included in the local agreement records but not in the global agreement records. However, the local office agreement may be constrained by some minimum terms required by headquarters. For example, headquarters may set a minimum delivery fee, may require payment of costs or fees, and so on. These terms may be included in the local agreement records.

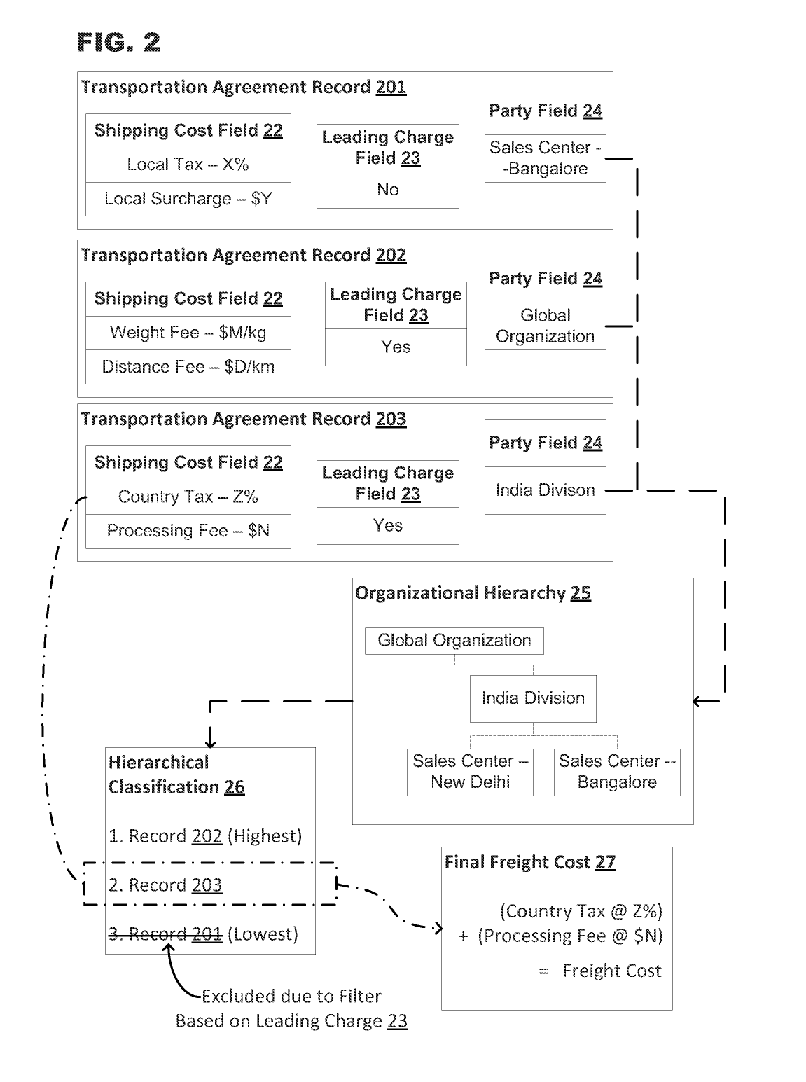

FIG. 2 shows an exemplary hierarchical classification of transportation agreement records 201 to 203. In this example, these three records 201 to 203 may have been identified as being associated with a shipment of goods from Bangalore, India. Each of the transportation agreement records 201 to 203 may include a shipping cost field 22, a leading charge indicator field 23, and party field 24. The shipping cost field 22 may include shipping cost information and/or rates. The leading charge field 23 may include data indicating which, if any, charge elements in the shipping fields 22 cover a particular transportation charge in each respective agreement record 201 to 203. The leading charge field 23 may indicate that the shipping costs in a respective agreement are particularly relevant for calculating the freight cost. Other indications may be used in other situations.

The party field 24 may specify one or more of the parties who negotiated or is otherwise responsible for the agreement in the respective agreement record 201 to 203. In this example, the data in the party field 24 may be compared with data in a hierarchical organizational chart 25 of the organization to identify a relatively hierarchy of the parties in each of the agreement records 201 to 203. Since the Sales Center—Bangalore party is classified at the lowest hierarchical level of the three parties in records 201 to 203, agreement record 201 may be classified at a lowest hierarchical level. Since the Global Organization party in record 202 is classified at the highest hierarchical level of the three parties in records 201 to 203, agreement record 202 may be classified at a highest hierarchical level. The remaining record 203 with India Division party may be classified at a middle hierarchical level between the other two records 201 and 202.

Although record 201 is classified at the lowest hierarchical level, it is not designated as a leading charge, so it may be excluded from consideration. Of the remaining records 202 and 203 that are designated as leading charges, record 203 is classified at the lower level, so record 203 may be selected and the final freight cost 27 may be calculated using the shipping costs 22 from record 203.

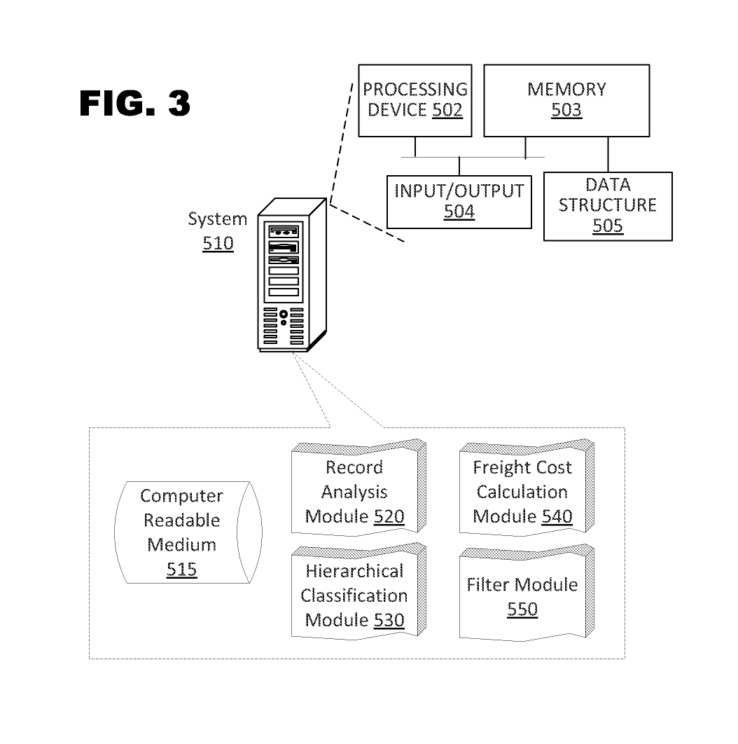

FIG. 3 shows an exemplary architecture. System 510 may include a computer readable medium 515 storing application modules that may include a record analysis module 520, hierarchical classification module 530, freight cost calculation module 540, and/or filter module 550. In some instances, modules 520 to 550, and/or other modules or components of the system 510 may be stored in a memory 503 or data structure 505 that is separate from the computer readable medium 515 and/or the system 510. System 510 may also include a processing device 502, memory 503 storing loaded data or a loaded data structure 505, and an input/output interface 504, all of which may be interconnected via a system bus.

The record analysis module 520 may include functionality for identifying, in some instance through or using the processing device 502, a plurality of transportation agreement records containing data fields specifying shipping costs associated with a shipping route for a good and identifying a party to a transportation agreement. The record analysis module 520 may also including functionality for associating a transportation agreement record with the shipping route when a geographic coverage region specified in the respective transportation agreement record includes at least one location that is part of the shipping route. The record analysis module 520 may also identify the shipping route from at least one of an origin and a destination of the good specified in the sales order object.

The hierarchical classification module 530 may include functionality for comparing a relative hierarchical level of the party in each of the identified transportation agreement records and hierarchically classifying each of the identified transportation agreement records according to the compared relative hierarchical level of each respective party. The hierarchical classification module 530 may compares the relative hierarchical level of each of the identified parties based on a geographic region associated with each party with each party's relative hierarchical level proportional to a size of the geographic region associated with the respective party. The hierarchical classification module 530 may compare the relative hierarchical level of each of the identified parties based on a position of each party on a hierarchical organizational chart.

The freight cost calculation module 540 may include functionality for simulating total shipping costs associated with the shipping route based on data in at least one of the shipping cost data fields of at least one of the classified transportation agreement records and calculating the freight cost from data in at least one of the shipping cost data fields in a remaining transportation agreement record classified at a lowest hierarchical level after the filtering.

The filter module 550 may include functionality for filtering out those classified transportation agreement records that are not identified as leading charge types based on a leading charge type indicator associated with each of the classified transportation agreement records.

The output interface 504 may include an interface for outputting the calculated freight cost for the good to an output device. The output device may include a memory, a display screen, a printer, or a computing device. The output interface 504 may enable communications between the system 510 and the output device connected to the interface 504.

System 510 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 503 may contain different components for retrieving, presenting, changing, and saving data and may include the computer readable medium 515. Memory 503 may include a variety of memory devices, for example, Dynamic Random Access Memory (DRAM), Static RAM (SRAM), flash memory, cache memory, and other memory devices. Additionally, for example, memory 503 and processing device(s) 502 may be distributed across several different computers that collectively comprise a system.

Processing device 502 may perform computation and control functions of a system and comprises a suitable central processing unit (CPU). Processing device 502 may include a single integrated circuit, such as a microprocessing device, or may include any suitable number of integrated circuit devices and/or circuit boards working in cooperation to accomplish the functions of a processing device. Processing device 502 may execute computer programs, such as object-oriented computer programs, within memory 503.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, although the system 510 is shown as a single integrated system, in some instances the functionality in system 510 may be distributed over two or more systems that are configured to appear as a functionally integrated single system.

We claim:

1. A computer-implemented method for calculating a freight cost for a good comprising:
identifying a plurality of transportation agreement records containing data fields specifying shipping costs associated with a shipping route for the good and identifying a party to a transportation agreement;
comparing a relative hierarchical level of the party in each of the identified transportation agreement records;
hierarchically classifying, using a processing device, each of the identified transportation agreement records according to the compared relative hierarchical level of each respective party;
simulating total shipping costs associated with the shipping route based on data in at least one of the shipping cost data fields of at least one of the classified transportation agreement records;
filtering out those classified transportation agreement records that are not identified as leading charge types based on a leading charge type indicator associated with each of the classified transportation agreement records;
calculating the freight cost from data in at least one of the shipping cost data fields in a remaining transportation agreement record classified at a lowest hierarchical level after the filtering; and
outputting the calculated freight cost for the good.

2. The method of claim 1, wherein the comparing of the relative hierarchical level of each of the identified parties is based on a position of each party on a hierarchical organizational chart.

3. The method of claim 1, wherein the comparing of the relative hierarchical level of each of the identified parties is based on a geographic region associated with each party with each party's relative hierarchical level proportional to a size of the geographic region associated with the respective party.

4. The method of claim 1, further comprising:
simulating total shipping costs associated with the shipping route based on data in at least one of the shipping cost data fields of each of the classified transportation agreement records; and
selecting one of a plurality of leading charge type indicators that are associated with the simulated total shipping costs.

5. The method of claim 1, further comprising identifying the shipping route from order information included in a sales order object.

6. The method of claim 5, wherein the shipping route is identified from at least one of an origin and a destination of the good specified in the sales order object.

7. The method of claim 1, further comprising associating a transportation agreement record with the shipping route when a geographic coverage region specified in the respective transportation agreement record includes at least one location that is part of the shipping route.

8. A non-transitory computer readable medium comprising stored instructions, that when executed by a processing device, cause the processing device to:
identify a plurality of transportation agreement records containing data fields specifying shipping costs associated with a shipping route for the good and identifying a party to a transportation agreement;
compare a relative hierarchical level of the party in each of the identified transportation agreement records;
hierarchically classify each of the identified transportation agreement records according to the compared relative hierarchical level of each respective party;
simulate total shipping costs associated with the shipping route based on data in at least one of the shipping cost data fields of at least one of the classified transportation agreement records;
filter out those classified transportation agreement records that are not identified as leading charge types based on a leading charge type indicator associated with each of the classified transportation agreement records;
calculate a freight cost from data in at least one of the shipping cost data fields in a remaining transportation agreement record classified at a lowest hierarchical level after the filtering; and
output the calculated freight cost for the good.

9. The computer readable medium of claim 8, wherein the comparing of the relative hierarchical level of each of the identified parties is based on a position of each party on a hierarchical organizational chart.

10. The computer readable medium of claim 8, wherein the comparing of the relative hierarchical level of each of the identified parties is based on a geographic region associated with each party with each party's relative hierarchical level proportional to a size of the geographic region associated with the respective party.

11. The computer readable medium of claim 8, further comprising additional stored instructions, that when executed by a processing device, cause the processing device to:
simulate total shipping costs associated with the shipping route based on data in at least one of the shipping cost data fields of each of the classified transportation agreement records; and
select one of a plurality of leading charge type indicators that are associated with the simulated total shipping costs.

12. The computer readable medium of claim 8, further comprising additional stored instructions, that when executed by a processing device, cause the processing device to identify the shipping route from order information included in a sales order object.

13. The computer readable medium of claim 12, wherein the shipping route is identified from at least one of an origin and a destination of the good specified in the sales order object.

14. The computer readable medium of claim 8, further comprising additional stored instructions, that when executed by a processing device, cause the processing device to associate a transportation agreement record with the shipping route when a geographic coverage region specified in the respective transportation agreement record includes at least one location that is part of the shipping route.

15. A system comprising:
a processing device;
a record analysis module for identifying, through the processing device, a plurality of transportation agreement records containing data fields specifying shipping costs associated with a shipping route for a good and identifying a party to a transportation agreement;
a hierarchical classification module for comparing a relative hierarchical level of the party in each of the identified transportation agreement records and hierarchically classifying each of the identified transportation agreement records according to the compared relative hierarchical level of each respective party;
a filter module for filtering out those classified transportation agreement records that are not identified as leading charge types based on a leading charge type indicator associated with each of the classified transportation agreement records;
a freight cost calculation module for simulating total shipping costs associated with the shipping route based on data in at least one of the shipping cost data fields of at least one of the classified transportation agreement records and calculating the freight cost from data in at least one of the shipping cost data fields in a remaining transportation agreement record classified at a lowest hierarchical level after the filtering; and
an output interface for outputting the calculated freight cost for the good to an output device.

16. The system of claim 15, where the output interface is an interface for transferring data to a memory, a display screen, or a computing device.

17. The system of claim 15, wherein the hierarchical classification module compares the relative hierarchical level of each of the identified parties based on a position of each party on a hierarchical organizational chart.

18. The system of claim 15, wherein the hierarchical classification module compares the relative hierarchical level of each of the identified parties based on a geographic region associated with each party with each party's relative hierarchical level proportional to a size of the geographic region associated with the respective party.

19. The system of claim 15, wherein the record analysis module identifies the shipping route from at least one of an origin and a destination of the good specified in the sales order object.

20. The system of claim 15, wherein the record analysis module associates a transportation agreement record with the shipping route when a geographic coverage region specified in the respective transportation agreement record includes at least one location that is part of the shipping route.
